(19) United States
(12) Patent Application Publication
(10) Pub. No.: US 2026/0338007 A1
(43) Pub. Date: Oct. 29, 2026

(54) CINCH AND ICE BREAKING LATCH AND ACTUATOR

(71) Applicant: MAGNA CLOSURES INC., Newmarket (CA)

(72) Inventor: Kris TOMASZEWSKI, Newmarket (CA)

(21) Appl. No.: 19/651,730

(22) Filed: Apr. 19, 2026

Related U.S. Application Data
(60) Provisional application No. 63/792,991, filed on Apr. 23, 2025.

(51) Int. Cl. E05B 81/20; E05B 77/34; E05B 81/30

(52) U.S. Cl. CPC E05B 81/20; E05B 77/34; E05B 81/30

(57) ABSTRACT

A power latch assembly includes a ratchet moveable between a primary striker capture position, a secondary striker capture position, and a striker releasing position. A pawl is moveable between a ratchet releasing position, whereat the ratchet is moveable to the striker releasing position, a secondary ratchet holding position to hold ratchet in the secondary striker capture position, and a primary ratchet holding position to hold ratchet in the primary striker capture position. A cinch lever is movable about an axis between a cinch lever rest position disengaged from ratchet, and a cinch lever deployed position moving ratchet to the primary striker capture position. A present lever is movable about the axis between a present lever rest position disengaged from ratchet, and a present lever deployed position moving ratchet toward the striker releasing position. An actuator moves cinch lever and present lever between their respective rest and deployed positions.

### CROSS-REFERENCE TO RELATED APPLICATIONS

This application claims the benefit of U.S. Provisional Application Serial No. 63/792,991, filed Apr. 23, 2025, which is incorporated herein by way of reference in its entirety.

### FIELD

The present disclosure relates generally to a latch system for a vehicle closure panel and, more particularly, to a power latch assembly having a power cinch and power present actuator assembly.

### BACKGROUND

This section provides background information related to the present disclosure which is not necessarily prior art.

In view of increased consumer demand for motor vehicles equipped with advanced comfort and convenience features, many modern motor vehicles are now provided with passive entry systems to permit locking and release of closure panels (i.e., doors, tailgates, liftgates and decklids) without use of a traditional key-type entry system. In this regard, some popular features now available with vehicle latch systems include power locking/unlocking, power release, power cinching, and power presenting. These “powered” features are provided by a latch assembly mounted to the closure panel and which includes a ratchet and pawl type of latching mechanism controlled via multiple, separately actuated electric actuators. Typically, the closure panel is held in a closed position by virtue of the ratchet being positioned in a striker capture position to releasably retain a striker that is mounted to a structural portion of the vehicle. The ratchet is held in its striker capture position by the pawl engaging the ratchet in a ratchet holding position. In most ratchet and pawl type latching mechanisms, the pawl is operable in a secondary ratchet holding position to retain the ratchet in a secondary striker capture position and in primary ratchet holding position to retain the ratchet in a primary striker capture position. Latch assemblies providing a power cinching operation are typically equipped with a cinching mechanism operated by an electric cinching actuator. Commonly, the cinching mechanism is directly connected to the ratchet and, when actuated, is operable for moving the ratchet from its secondary striker capture position to its primary or cinched striker capture position, thereby cinching the closure panel in its closed position.

To release the closure panel from its closed position, a release mechanism, separate from the cinch mechanism, is actuated for moving the pawl from its ratchet holding position into a ratchet release position, whereby a ratchet biasing arrangement forcibly pivots the ratchet from its primary striker capture position into an open position or striker release position so as to release the striker. In latch assemblies providing a power release feature, the release mechanism is typically controlled by a separate power release actuator from that of the cinching mechanism. Latch assemblies providing a power presenting operation are typically equipped with a presenting mechanism operated by an electric presenting actuator separate from the cinching actuator. Commonly, the presenting mechanism is directly connected to the ratchet and, when actuated, is operable for moving the ratchet from its primary striker capture position toward its striker release position, thereby presenting the closure panel toward its open position.

Although current power latch, power cinch, and power present assemblies are sufficient to meet regulatory requirements and provide enhanced comfort and convenience, a need still exists to advance the technology and provide alternative power latch, power cinch, and power present assemblies that address and overcome at least some of the known shortcomings, such as reducing the number of components, reducing the complexity of operation and assembly, reducing the package size of, and improving the economy of manufacture and assembly.

### SUMMARY

This section provides a general summary of the disclosure and is not intended to be a comprehensive disclosure of all features, advantages, aspects and objectives associated with the inventive concepts described and illustrated in the detailed description provided herein.

It is an aspect of the present disclosure to provide a power latch having a power cinch mechanism and a power ice breaking mechanism, also referred to as power present mechanism, for a motor vehicle closure system configured to provide a cinch system and present system that addresses and overcomes at least the shortcomings discussed above.

In accordance with another aspect, a power latch assembly for a motor vehicle closure panel moveable between a closed position, a partially open position, and a fully open position is provided. The power latch assembly includes a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position. Power latch assembly further includes a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position. Power latch assembly further includes a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position. Power latch assembly further includes a present lever movable about the axis between a present lever rest position, whereat the present lever is disengaged from the ratchet, and a present lever deployed position, whereat the present lever is engaged with the ratchet to move the ratchet toward the striker releasing position. Further, power latch assembly includes an actuator configured to move the cinch lever between the cinch lever rest position and the cinch lever deployed position, and to move the present lever between the present lever rest position and the present lever deployed position.

In accordance with another aspect of the disclosure, power latch assembly includes a cinch cable operably coupled to the cinch lever and the actuator, and a present cable operably coupled to the present lever and the actuator.

In accordance with another aspect of the disclosure, the cinch cable is drivable by the actuator to move the cinch lever from the cinch lever rest position to the cinch lever deployed position, during which the present cable remains stationary.

In accordance with another aspect of the disclosure, the cinch lever is biased toward the cinch lever rest position by a cinch lever biasing member.

In accordance with another aspect of the disclosure, the present cable is drivable by the actuator to move the present lever from the present lever rest position to the present lever deployed position, during which the cinch cable remains stationary.

In accordance with another aspect of the disclosure, the present lever is biased toward the present lever rest position by a present lever biasing member.

In accordance with another aspect of the disclosure, the cinch lever is drivable by the actuator from the cinch lever rest position to the cinch lever deployed position, during which the present lever remains stationary.

In accordance with another aspect of the disclosure, the present lever is drivable by the actuator from the present lever rest position to the present lever deployed position, during which the cinch lever remains stationary.

In accordance with another aspect of the disclosure, the ratchet is rotatable about a ratchet axis, with the ratchet having a ratchet arm extending radially outwardly from the ratchet axis, wherein the cinch lever is engageable with a first side of the ratchet arm to move the ratchet to the primary striker capture position, and the present lever is engageable with a second side of the ratchet arm to move the ratchet toward the striker releasing position.

In accordance with another aspect of the disclosure, power latch assembly includes a cinch pulley moveable about the axis and a present pulley movable about the axis, wherein the cinch pulley has a cinch cog configured to move the cinch lever from the cinch lever rest position to the cinch lever deployed position, and the present pulley has a present cog configured to move the present lever from the present lever rest position to the present lever deployed position.

In accordance with another aspect, there is provided a power latch assembly for a closure panel of a motor vehicle, including, a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position, a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position, a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position, a present lever movable about the axis between a present lever rest position, whereat the present lever is disengaged from the ratchet, and a present lever deployed position, whereat the present lever is engaged with the ratchet to move the ratchet toward the striker releasing position, and where the cinch lever is coupled to a first cable, where actuation of the first cable causes movement of the cinch lever without causing movement of the present lever, where the present lever is coupled to a second cable, where actuation of the second cable causes movement of the cinch lever without causing movement of the cinch lever.

In accordance with another aspect, provided is a system for moving a closure panel of a motor vehicle in a cinching direction and in an opposite ice-breaking direction, the system including a power latch assembly having a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position, a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position, a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position, where the cinch lever is coupled to a first cable, a present lever movable about the axis between a present lever rest position, whereat the present lever is disengaged from the ratchet, and a present lever deployed position, whereat the present lever is engaged with the ratchet to move the ratchet toward the striker releasing position, where the present lever is coupled to a second cable, and an actuator having a single pulley coupled to the first cable and to the second cable; where rotation of the single pulley in a first direction causes the first cable to actuate the cinch lever, and where rotation of the single pulley in a second direction opposite the first direction causes the second cable to actuate the present lever.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations such that the drawings are not intended to limit the scope of the present disclosure.

FIG. 1A is a plan view of a power latch assembly for a motor vehicle closure panel according to an aspect of the disclosure shown in a secondary latched state;

FIG. 1B is a view similar to FIG. 1A with the power latch assembly shown being cinched from the secondary latched state to a primary latched state;

FIG. 2A is a plan view of the power latch assembly of FIG. 1 shown in the primary latched state; and

FIG. 2B is a view similar to FIG. 2A with the power latch assembly shown being presented from the primary latched state to an unlatched state.

Corresponding reference numerals are used throughout all of the drawings to indicate corresponding parts.

### DETAILED DESCRIPTION OF EXEMPLARY EMBODIMENTS

An example embodiment of a cinch and ice breaking latch assembly for a motor vehicle closure panel and actuator therefore will now be described more fully with reference to the accompanying drawings. To this end, the example embodiment of a latch assembly is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

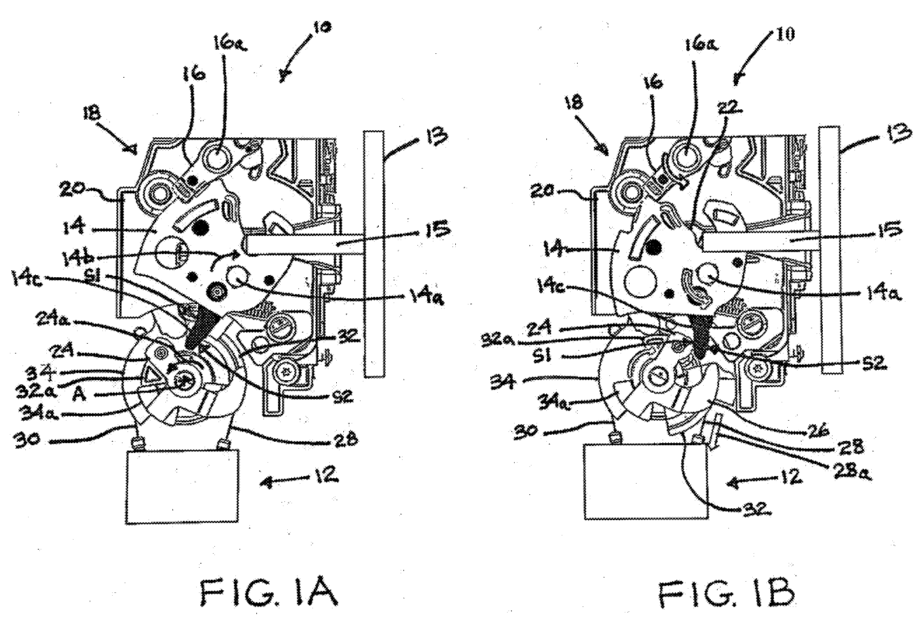

Now referring to FIG. 1, there is shown a cinch and ice breaking power latch, referred to hereafter as power latch assembly or latch 10 in accordance with an aspect of the disclosure. Latch 10 is operable via selective actuation of an actuator 12, such as discussed in co-owned publication US 2024/01332218 to Johann et al., published on Apr. 25, 2024, which is incorporated herein by way of reference in its entirety, to drive a ratchet 14 to forcibly engage a striker 15 fixed to a closure panel 13 of a motor vehicle to move the closure panel 13 from a partially open position into a fully closed position, and is further operable to drive the ratchet 14 to forcibly engage the striker 15 and move closure panel 13 from the fully closed position toward an open position. A closure panel for an automotive vehicle is discussed in co-owned patent number US 11674338 to Tomaszewski, issued on Jun. 13, 2023, which is incorporated herein by way of reference in its entirety.

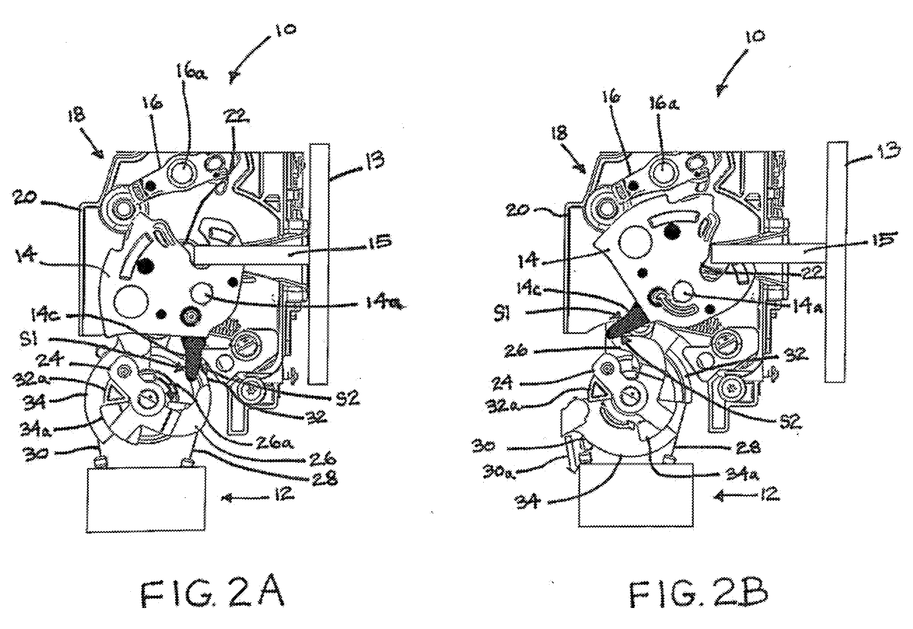

Latch 10 includes a latch mechanism 18 including, by way of example and without limitation, the ratchet 14 and a pawl 16 supported by a frame plate 20 for pivotal movement about respective ratchet and pawl pins 14a, 16a, with ratchet pin 14a defining a ratchet axis and pawl pin 16a defining a pawl axis. Ratchet 14 is moveable between a closed position (FIGS. 1B and 2A), whereat the ratchet 14 captures the striker 15 to hold the closure panel 13 in a closed position, a secondary striker capture position (FIG. 1A), whereat the ratchet 14 captures the striker 15 to hold the closure panel 13 in a partially closed position, and a striker releasing position (FIG. 2B), whereat the ratchet 14 allows the striker 15 to be released from a slot 22 of the ratchet 14, thereby allowing the closure panel 13 to be moved to an open position. The pawl 16 is moveable between a ratchet releasing position (FIGS. 2A and 2B), whereat the ratchet 14 is moveable to the striker releasing position, a secondary ratchet holding position (FIG. 1A), whereat the ratchet 14 is held in the secondary striker capture position, and a primary ratchet holding position (FIG. 1B), whereat the ratchet 14 is held in the primary striker capture position.

A cinch lever 24 is movable, via selective actuation of the actuator 12, against a bias imparted by a cinch lever biasing member 24a, such as a torsion spring, about an axis A between a cinch lever rest position (FIG. 1A, ratchet 14 shown in the secondary striker capture position), whereat the cinch lever 24 is disengaged from the ratchet 14, and a cinch lever deployed position (FIG. 1B), whereat the cinch lever 24 is engaged with the ratchet 14 to move the ratchet 14 against a bias imparted by a ratchet biasing member 14b, such as a torsion spring, from the secondary striker capture position to the primary striker capture position (FIG. 1B). Upon cinching the ratchet 14 to the primary striker capture position, the vehicle closure panel 13 is moved to its fully closed position, whereupon the actuator 12 is automatically reset to its home position, thereby allowing cinch lever 24 to automatically return to its cinch lever rest position under the bias force imparted by the cinch lever biasing member 24a.

A present lever 26 is movable via selective actuation of the actuator 12, against a bias imparted by a present lever biasing member 26a, such as a torsion spring, about the axis A between a present lever rest position (FIG. 2A, ratchet 14 shown in the primary striker capture position), whereat the present lever 26 is disengaged from the ratchet 14, and a present lever deployed position (FIG. 2B), whereat the present lever 26 is engaged with the ratchet 14 to forcibly move the ratchet 14 toward the striker releasing position, thereby causing the ratchet 14 to move and overcome unwanted resistance, such as from a buildup of ice, by way of example and without limitation. Upon presenting the ratchet 14 to the striker releasing position, the striker 15 is permitted to be removed from the slot 22 and outwardly from the ratchet 14, thereby allowing the vehicle closure panel 13 to be moved to its open position, whereupon the actuator 12 is reset to its home position, thereby allowing present lever 26 to automatically return to its present lever rest position under the bias force imparted by the present lever biasing member 26a.

During actuation of the actuator 12 in the cinching operation of FIG. 1B, a cinch cable 28 that is operably coupled to the cinch lever 24 is pulled along a direction 28a by the actuator 12 to move the cinch lever 24 against the bias force imparted by cinch lever biasing member 24a, and during actuation of the actuator 12 in the presenting operation of FIG. 2B, a present cable 30 that is operably coupled to the present lever 26 is pulled by the actuator 12 to move the present lever 26 against the bias force imparted by present lever biasing member 26a. As such, the cinch cable 28 is drivable by the actuator 12 to move the cinch lever 24 from the cinch lever rest position to the cinch lever deployed position, during which the present cable 30 remains stationary, and the present cable 30 is drivable by the actuator 12 to move the present lever 26 from the present lever rest position to the present lever deployed position, during which the cinch cable 28 remains stationary. The present cable 30 is permitted to remain stationary during the cinching process via a lost motion coupling of the present cable 30 to a drive gear of actuator 12. Similarly, cinch cable 28 is permitted to remain stationary during the presenting process via a lost motion coupling of the cinch cable 28 to the drive gear of actuator 12. Accordingly, in view of the lost motion connections of the cinch cable 28 and the present cable 30 to the actuator 12, when the cinch lever is driven by the actuator 12 from the cinch lever rest position to the cinch lever deployed position, the present lever 26 remains stationary in the present lever rest position, and further, when the present lever 26 is driven by the actuator 12 from the present lever rest position to the present lever deployed position, the cinch lever 24 remains stationary in the cinch lever rest position.

To facilitate engagement of the cinch lever 24 and the present lever 26 with the ratchet 14 during the cinching operation and presenting operation, respectively, the ratchet 14 has a ratchet arm 14c extending radially outwardly from the ratchet axis defined by ratchet pin 14a. The cinch lever 24, during the cinching operation, is engageable with a first side S1 (FIG. 1B) of the ratchet arm 14c to move the ratchet 14 to the primary striker capture position, while the present lever 26, during the presenting operation, is engageable with a second side S2 (FIG. 2B) of the ratchet arm 14c to move the ratchet 14 toward the striker releasing position.

In accordance with a further aspect of the disclosure, a cinch pulley 32 moveable about the axis A and a present pulley 34 movable about the axis A are provided. With the cinch lever 24, cinch pulley 32, present lever 26, and present pulley 34 each being supported for pivotal movement about the same axis A, the package size of latch 10 is minimized, thereby providing space savings, as well as enhancing economies and minimizing complexities of assembly and operation. The cinch pulley 32 has a cinch cog 32a configured for abutment with the cinch lever 24 to move the cinch lever 24, during the cinching operation, from the cinch lever rest position to the cinch lever deployed position. The present pulley 34 has a present cog 34a configured for abutment with the present lever 26 to move the present lever 26, during the presenting operation, from the present lever rest position to the present lever deployed position. It is to be recognized that the cinch lever biasing member 24a maintains the cinch lever 24 in constant biased engagement with the cinch cog 32a, and the present lever biasing member 26a maintains the present lever 26 in constant biased engagement with the present cog 34a, and thus, noise is minimized throughout operation of latch 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a closure panel of a motor vehicle, comprising:
a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position;
a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position;
a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position;
a present lever movable about the axis between a present lever rest position, whereat the present lever is disengaged from the ratchet, and a present lever deployed position, whereat the present lever is engaged with the ratchet to move the ratchet toward the striker releasing position; and
an actuator configured to move the cinch lever between the cinch lever rest position and the cinch lever deployed position, and to move the present lever between the present lever rest position and the present lever deployed position.

2. The power latch assembly of claim 1, further including a cinch cable operably coupled to the cinch lever and the actuator, and a present cable operably coupled to the present lever and the actuator.

3. The power latch assembly of claim 2, wherein the cinch cable is drivable by the actuator to move the cinch lever from the cinch lever rest position to the cinch lever deployed position, during which the present cable remains stationary.

4. The power latch assembly of claim 3, wherein the cinch lever is biased toward the cinch lever rest position by a cinch lever biasing member.

5. The power latch assembly of claim 2, wherein the present cable is drivable by the actuator to move the present lever from the present lever rest position to the present lever deployed position, during which the cinch cable remains stationary.

6. The power latch assembly of claim 5, wherein the present lever is biased toward the present lever rest position by a present lever biasing member.

7. The power latch assembly of claim 1, wherein the cinch lever is drivable by the actuator from the cinch lever rest position to the cinch lever deployed position, during which the present lever remains stationary.

8. The power latch assembly of claim 1, wherein the present lever is drivable by the actuator from the present lever rest position to the present lever deployed position, during which the cinch lever remains stationary.

9. The power latch assembly of claim 1, wherein the ratchet is rotatable about a ratchet axis, the ratchet having a ratchet arm extending radially outwardly from the ratchet axis, the cinch lever being engageable with a first side of the ratchet arm to move the ratchet to the primary striker capture position, the present lever being engageable with a second side of the ratchet arm to move the ratchet toward the striker releasing position.

10. The power latch assembly of claim 1, further including a cinch pulley moveable about the axis and a present pulley movable about the axis, the cinch pulley having a cinch cog configured to move the cinch lever from the cinch lever rest position to the cinch lever deployed position, the present pulley having a present cog configured to move the present lever from the present lever rest position to the present lever deployed position.

11. A power latch assembly for a closure panel of a motor vehicle, comprising:
a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position;
a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position;
a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position;
a present lever movable about the axis between a present lever rest position, whereat the present lever is disengaged from the ratchet, and a present lever deployed position, whereat the present lever is engaged with the ratchet to move the ratchet toward the striker releasing position; and
wherein the cinch lever is coupled to a first cable, wherein actuation of the first cable causes movement of the cinch lever without causing movement of the present lever;
wherein the present lever is coupled to a second cable, wherein actuation of the second cable causes movement of the cinch lever without causing movement of the cinch lever.

12. A system for moving a closure panel of a motor vehicle in a cinching direction and in an opposite ice-breaking direction, the system comprising:
a power latch assembly having;
a ratchet moveable between a primary striker capture position, whereat the ratchet captures a striker to hold the closure panel in a closed position, a secondary striker capture position, whereat the ratchet captures the striker to hold the closure panel in a partially closed position, and a striker releasing position, whereat the ratchet allows the striker to be released from the ratchet and the closure panel to be moved to an open position;
a pawl moveable between a ratchet releasing position, whereat the ratchet is moveable to the striker releasing position, a secondary ratchet holding position, whereat the ratchet is held in the secondary striker capture position, and a primary ratchet holding position, whereat the ratchet is held in the primary striker capture position;
a cinch lever movable about an axis between a cinch lever rest position, whereat the cinch lever is disengaged from the ratchet, and a cinch lever deployed position, whereat the cinch lever is engaged with the ratchet to move the ratchet to the primary striker capture position, wherein the cinch lever is coupled to a first cable;
a present lever movable about the axis between a present lever rest position, whereat the present lever is disengaged from the ratchet, and a present lever deployed position, whereat the present lever is engaged with the ratchet to move the ratchet toward the striker releasing position, wherein the present lever is coupled to a second cable; and
an actuator having a single pulley coupled to the first cable and to the second cable; wherein rotation of the single pulley in a first direction causes the first cable to actuate the cinch lever, and wherein rotation of the single pulley in a second direction opposite the first direction causes the second cable to actuate the present lever.
